(19) United States
(12) Patent Application Publication
(10) Pub. No.: US 2002/0122388 A1
(43) Pub. Date: Sep. 5, 2002

(54) Dynamically reconfigurable intelligent content-based network

(76) Inventor: Taher Behbehani, Alexandria, VA (US)

Correspondence Address: Taher Behbehani, 4350 La Jolla Village Drive Suite 450, San Diego, CA, 92122, US

(21) Appl. No.: 09/799,415

(22) Filed: Mar. 5, 2001

(51) Int. Cl. H04J 3/14

(52) U.S. Cl. 370/238; 370/254; 370/400

(57) ABSTRACT

A dynamically reconfigurable intelligent content-based network includes a plurality of network users, a plurality of content providers responsive to requests from the network users, and a plurality of communication nodes, a subset of which are interconnected between each network user and each content provider. The network further includes a content manager that configures each communication node for communication within one of several content cells. Each content cell is associated with a content type, and formed according to data traffic of each content type, and network performance parameters. The content manager continually monitors the network traffic over each content cell to dynamically reconfigure the size of each cell, and subcells within each cell, for optimized performance and revenue generation.

### BACKGROUND OF THE INVENTION

1. Field of the Invention

This invention generally relates to data communications, and more particularly to a network topology for communication of different types of content.

2. Description of the Related Art

A network refers to a system of interconnected communication nodes for communicating information. One type of network of great contemporary importance is the internet. The internet refers to the collection of communication nodes on which data is communicated according to an internet protocol. The internet protocol is a continually advancing, but open, standard defining how data is to be communicated among many different interconnected nodes.

Internet data generally includes four main types of content: text, graphics, audio, and video. The internet and associated protocols were built on a foundational structure that was best suited for one mode of data communication, namely the communication of text and graphics for text/graphics-based personal computers. However, both the content types and end user technologies have changed. In addition to text and graphics, the internet now carries much more video and audio data. And in addition to traditional PCs, new and faster PCs, televisions, web radios and cell phones are connected to the internet for data communications.

Currently, the internet is set up to force all types of content destined for one network user into a single pipeline or route, where packets of data are routed from one node to the next regardless of content type. Under this configuration, packet size is standardized according to protocol in order to accommodate all content types. Thus, during communication of large data files, such as a video clip, a larger number of smaller packets stand a higher chance of being dropped or experiencing an error in transmission. The current internet network topology is not optimized for the various types of content being communicated on it.

As all data, regardless of content type, traverses the internet along shared routes, network users are usually charged a flat for network access, irrespective of relative usage of one content type or another. Therefore, one network user receiving, for example, only text might pay the same for access as another network user that receives only huge audio and video data files. While the latter network user consumes much more network resources, causing delays and overloading problems, the user is typically not charged a greater rate than the former network user.

### SUMMARY OF THE INVENTION

This invention relates to a system and method for forming a plurality of content cells for more efficient communication in a network. This invention also relates to a network topology that adapted for a more equitable scheme for distributing costs based on usage of network resources.

According to an embodiment of the invention, each content cell is formed of one more interconnected communication nodes. Each content cell corresponds to a content type. The content types include text, graphics, audio, and video. A network user is switched from one content cell to another based on a content type of data that the network user is receiving or transmitting. Each content cell can be enlarged by adding network resources to a content cell based on a content cell load. The content cell load depends on the amount of data traffic being communicated, the current network resources, including the number of communication nodes, being used in the content cell, and the specific content type of the data traffic.

In an embodiment of the invention, a content cell logically spans the network and connects content providers with network users. Content providers include network servers, such as may be found on the internet, for example. Network users include users who are connected to the network via a network access device, such as a computer hosting an internet browser application, for example. The communication nodes include routers, switches, bridges, taps, and other data-carrying devices that interconnect network users with content providers.

One embodiment of the invention includes a network manager that is configured to monitor data traffic on the network. The network manager is further configured to form a content cell based on that monitoring, and to switch either communication nodes in or out of a content cell, or network users in or out of a content cell.

The invention, embodied as a method for communicating in a network of interconnected communication nodes includes forming a content cell of a subset of the communication nodes, wherein the content cell is associated with a content type, and communicating data of the content type over the content cell. In another embodiment of the invention, a method includes monitoring data traffic over the communication nodes, parsing the data traffic into content types, there being a plurality of content types, and forming a plurality of content cells for communication of a corresponding content type. Each content cell includes a subset of the communication nodes. The method further includes dynamically switching communication nodes in or out of a content cell based on the data traffic that is monitored.

### BRIEF DESCRIPTION OF THE DRAWING

FIG. 1 is a topological view of a network illustrating a logical content cell according to an embodiment of the invention.

FIG. 2 is a process flow diagram illustrating a method according to an embodiment of the invention.

FIG. 3 illustrates another method according to an alternative embodiment of the invention.

### DETAILED DESCRIPTION OF THE PREFERRED EMBODIMENTS

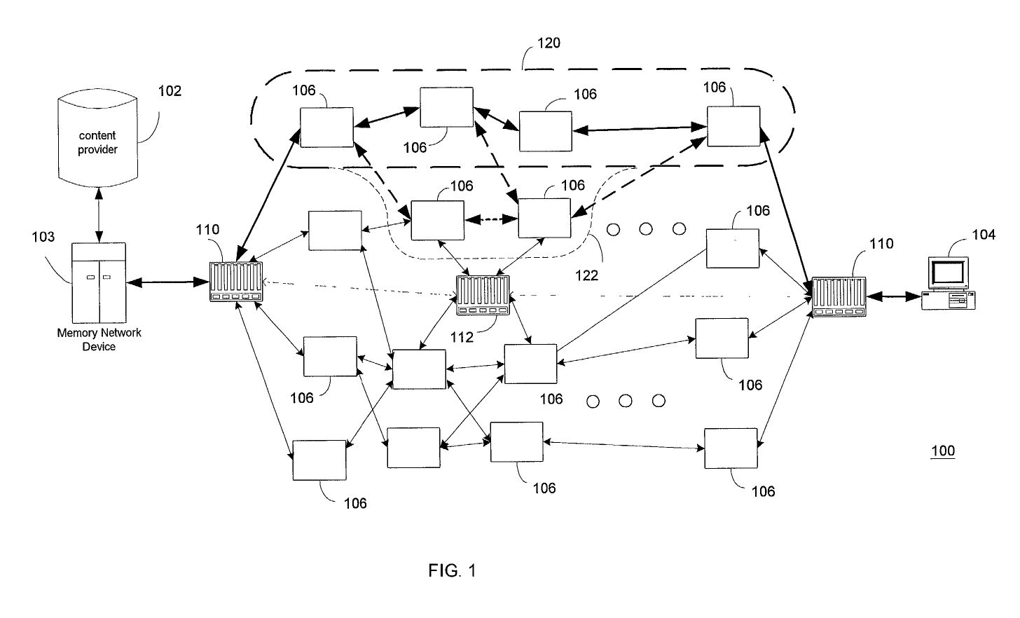

FIG. 1 is a block diagram of a network 100 according to one embodiment of the invention. The network 100 shown is simplified to illustrate particular advantages and functions of the invention, and as such should not be construed to limit the invention in any way. For instance, the network 100 is shown as including only a limited number of network elements, but the invention can apply to any sized network, having any number of interconnected network elements.

The network elements include a content provider 102 for providing content to a network user 104. The content provider 102 can be embodied as a web server connected in the internet, for example, or as a local server connected in a local area network. The content provider 102 includes a memory for storing data, and a transmission mechanism for communication of the data with the network 100. The data includes one or more of several types of content. The types of content that are provided by the content provider 102 include text, graphics, audio, video, or any combination of the above.

A memory network device 103 is connected between the content provider 102 and the network. The memory network device 103 may logically be provided within a first communication node to which data is communicated from the content provider 102. The communication node can be a router, for example. The memory network device 103 includes logic to recognize a content type of each set of data, and logic to parse, organize, relate, and store information based on the content types. The memory network device 103 is further configured to append a flag to a block of data that corresponds to a unique content type, thereby indicating the content type of the data to be communicated to the network.

The network user 104 is connected in the network 104, and is primarily a recipient of the data from the content provider 102. The network user 104 can be embodied as a browser application executed on a computer, or a client computer in a local network. The network user 104 is alternatively embodied as any device configured to request and receive data, such as a personal digital assistant, pager, cellular phone, laptop computer, or television, etc. In reality, the network 100 would include a large number of content providers 102 and a large number of network users 104

The content provider 102 and the network user 104 communicate along routes established and formed of a number of interconnected communication nodes 106. The communication nodes 106 refer to any data communication nodes such as routers, bridges, switching devices, modems, multiplexers, or codecs, etc. Traditionally, communication from a content provider 102 to a network user 104 is accomplished by establishing a virtual route among physically connected communication nodes 106, based on a forward-looking availability scheme. Consequently, the virtual route is almost never the most efficient or ideal route along which data travels.

In order to determine the best use of the communication nodes 106, a network traffic is monitored for determining a network load between a network user 104 and the content provider 102. A content manager is provided for monitoring the network traffic, for forming a number of content cells 120 made of some of the communication nodes 106, and for switching communication nodes 106 in and out of the content cells that are formed.

A content cell 120 is a network of interconnected network elements that form one or more data routes. The network elements can be communication nodes 106. A number of communication nodes 106 in a subcell 122 can be added or removed from a content cell 120. The subcell 122 is shown in FIG. 1 as being in addition to a content cell, however a subcell 122 can be formed within a content cell 120 as a dedicated route between a content provider 102 and a network user 104 for communication of data of a particular content. Moreover, the content cells 120 can be changed dynamically depending on usage requirements within the network 100, or within any one or more content cells 120. Accordingly, logical connections between communication nodes 106 are reconfigurable based on such required usage.

In an exemplary embodiment, content cell 120 can be a cell for communication of video content. Other content cells 120 may be formed for communication of other types of content. Each content cell 120 may be expanded or contracted depending on resource availability, user requests for content, network usage, and other factors. Each content cell 120 spans the entire network 100 logically.

Thus, each network user 104 “roams” within a number of content cells 120 simultaneously, but will use only one content cell 120 at a time to receive data.

The content manager includes a number of content manager nodes 110, preferably located at the edges of a content cell 120. The content manager nodes 110 determine what content cells 120 each network user 104 is roaming within, and are configured to switch a network user 104 from one content cell 120 to another, depending on the application program being used by the network user 104, and the content being delivered thereto. A content manager node 112 may also be interspersed within the communication nodes 106 of the network 100, for executing network monitoring and switching functions. Content manager nodes 110, 112 are preferably embodied as a server or storage device, for example, but are not limited to those embodiments.

Content cells are optimized for a content type. For instance, a content cell 120 is tuned to handle its cell load by adjusting data packet size, compression parameters, routing delays, etc. The content manager switches from one content cell 120 to another on a real-time basis. In one embodiment of the invention, the content manager employs predictive methods and modeling processes to minimize content cell switch times, and reduce latency. In an alternative embodiment, the content manager can execute a “hard” switch, and switch one content cell from handling one content type to handling a different content type. For example, an unused or underutilized content cell that has been initially formed to handle video may be switched to handle text. In this case, the switched content cell is reconfigured for optimal text communication for a period of time during which it is a text content cell.

In accordance with an embodiment of the invention, a cost structure for billing a network user can be suitably used. A cost can be calculated based on different, quantifiable factors: the content type being accessed by a network user; the content cell on which the content is routed; and the time in which access and delivery of the content occurs. Other cost factors may be used, such as the size of a data file being routed in a particular content cell, for example.

In one specific example, a content provider 102 provides a specific content to a content cell 120, such as video, audio or voice, graphics, or text. The content provider 102 associates a cost for providing the content. An additional cost may be calculated for subcontents, such as delivering text with video over a video content cell. Further, application-specific data can have an associated cost. For example, e-commerce text information can be streamed over a text content cell, but have a higher cost than news text. When a network user 104 requests data, the data could include more than one type of content, such as an audio file with accompanying graphics. Each type of content is preferably communicated over a dedicated content cell or subcell, that is optimized for the corresponding content. Thus, each time any content cell is accessed, the network user 104 may be billed for the access cost.

The content manager determines what a user is using, and switches the user into one or more content cells based on content type being delivered to the network user. Thus, the portion of the network accessible by the network user is optimized for that content type. If the network user wants to receive a different type of content, the content manager will switch the network user to a different content cell, i.e. a different network, that is optimized for the different type of content. Thus, content will travel along different routes depending on the content type, even though the same source and/or the same destination are maintained. In one example, a text content cell can be used to communicate wireless access protocol (WAP) compliant data a network user that uses a wireless interface to the network. Alternatively, the wireless user can receive audio over a separately-configured audio content cell.

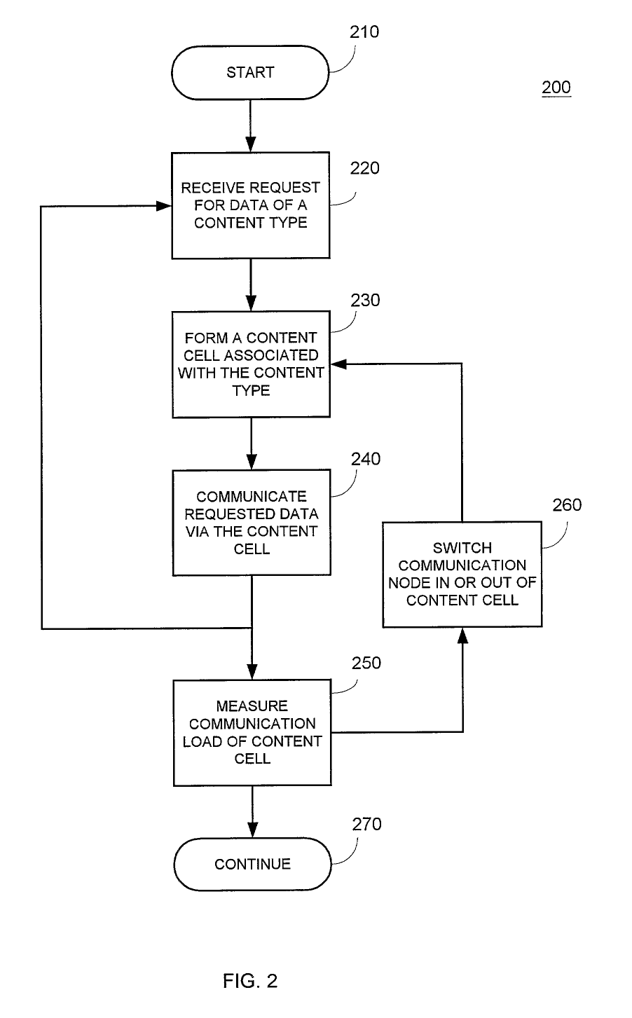

FIG. 2 illustrates one method 200 of communicating in a network of interconnected communication nodes, according to an embodiment of the invention. The method 200 begins at block 210. At block 220, a request is received from a network user for data of a particular content type. For instance, the network user could be operating a client workstation and requesting video data. At block 230, a content cell is formed. The content cell is associated with the content type related to the requested data. In one embodiment, the step at block 230 is executed in response to the step at block 220. In an alternative embodiment, the step at block 220 can be executed after one or more of the content cells have been established, in reference to block 230.

The requested data is communicated via the established content cell at block 240. However, each content cell is dynamically reconfigurable based on a number of system performance or user requirement factors. For instance, at block 250, the communication load of the content cell is measured. Factors used for measuring the communication load include, without limitation, packet size of data, compression ratios of the packets, encryption parameters, routing delay and latency limits, and load balance among all content cells. Other factors may also be utilized, such as predictive algorithms and statistical analysis of past performance and loads.

In response to such measuring, at block 260 one or more communication nodes are switched in or out of the content cell. Communication nodes can be switched from one content cell to another content cell, or from one subcell to another subcell. A subcell is a grouping of communication nodes within a content cell for communication of data from a particular content provider to a particular network user. The subcell is configured based on, without limitation, the type and amount of data requested or being delivered, content cell loads, the network user interface, etc.

Further illustrating the dynamic capabilities of the method 200 according to the invention, each content cell can be reconfigured based on each request from a network user to a content provider, as shown with reference to the path from block 240 to block 220. For example, a network user that had been receiving text data can request video data from the same or different content provider. In accordance with one embodiment of the invention, a new content cell is formed to accommodate the network user's new request for video data. The step at block 230 includes, but is not limited to, reconfiguring the number of communication nodes in pre-configured content cell, forming an entirely new content cell, or maintaining the same content cell.

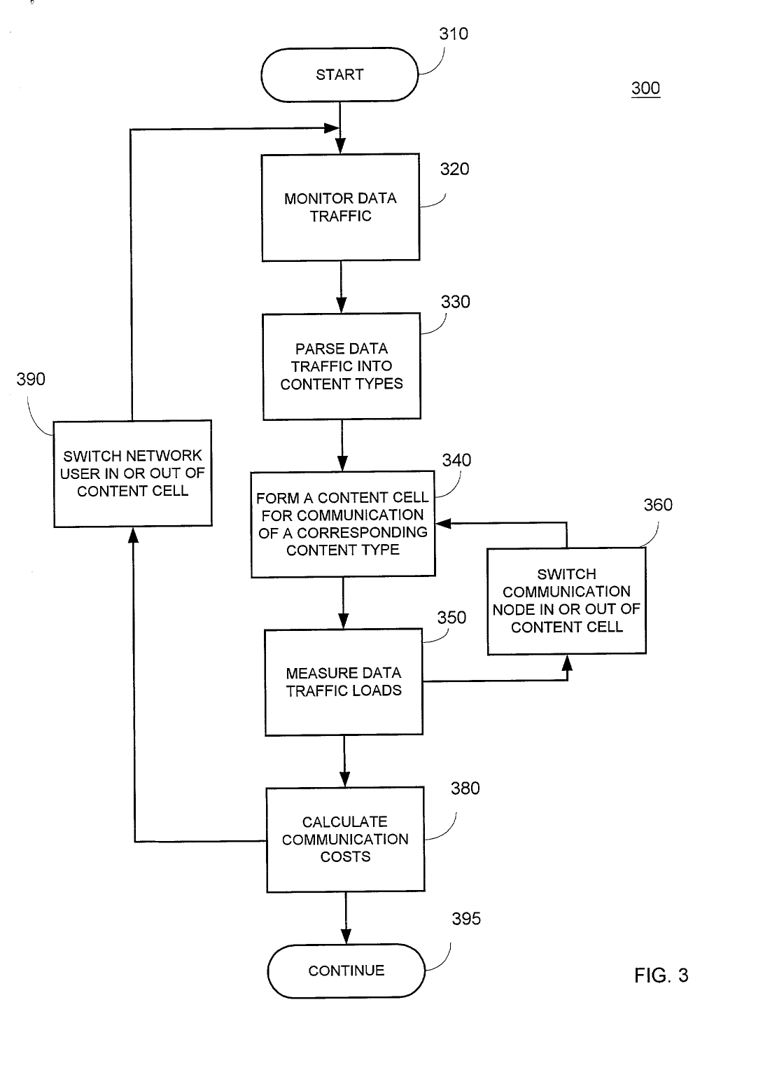

Turning now to FIG. 3, there is illustrated a method 300 of communicating in a network in accordance with an alternative exemplary embodiment of the invention. Method 300 is preferable executed by a content manager that is connected to all nodes in the network, including communication nodes, content providers, and network users. Further, the content manager could include a plurality of content manager nodes, each configured to administer a separate domain in the network. The method 300 begins at block 310. At block 320 data traffic on the network is monitored, preferably by the content manager. At block 330, the data traffic is divided into different content types. According to the preferred embodiment, the content types include text, graphics, audio and video. According to other embodiments, the data traffic can be divided based on factors that include, without limitation, security measures associated with the data traffic, required speed and/or throughput of the data traffic, and other performance requirements or characteristics.

At block 340, a content cell is formed according to the parsing of data traffic at block 330. Thus, a content cell is formed for each one of the different data types within the data traffic. At block 350, data traffic loads of the network are monitored. As described above, many factors can be employed to monitor data traffic loads, including, but not limited to, network user requirements, availability of communication nodes, packet size of data traffic, etc. In response to such measurements, communication nodes can be switched in or out of the content cells at block 360. Logic for executing such switching is well known to persons of ordinary skill in the art.

At block 380, communication costs are calculated. The communication costs include, without limitation, access to a content cell by a network user and/or content provider, a cost associated with a type of content or subtype of a particular content type, and the number of communication nodes utilized by the communication. Other costs may be calculated, for example, electronic commerce data can be assigned a higher cost than pure informational data. The cost calculation can be used to switch a user in or out of a particular content cell at block 390. For example, a network user can have a subscription for a certain amount of a particular content type, and when that amount is achieved, the network user is switched out of the content cell for that data type. In another embodiment, switching a network user from one content cell to another can optimize revenue for either the content providers and/or the content manager.

Other embodiments, combinations and modifications of this invention will occur readily to those of ordinary skill in the art in view of these teachings.

Therefore, this invention is to be limited only by the following claims, which include all such embodiments and modifications when viewed in conjunction with the above specification and accompanying drawings.

What is claimed is:

1. A method of communicating in a network of interconnected communication nodes, comprising:
forming a content cell of a subset of the communication nodes, wherein the content cell is associated with a content type; and
communicating data of the content type over the content cell.

2. The method of claim 1, further comprising receiving a request for data of the content type at a content provider node.

3. The method of claim 2, wherein the request is provided by a network user.

4. The method of claim 3, further comprising establishing a subcell including at least one of the communication nodes within the content cell, for communication of the data between the network user and the content provider node.

5. The method of claim 1, further comprising switching a communication node in or out of the content cell according to a content cell load.

6. The method of claim 3, further comprising switching the network user in or out of the content cell according to the request for data.

7. The method of claim 1, further comprising dynamically reconfiguring one or more communication nodes of the network to be included or removed from the content cell.

8. The method of claim 7, wherein the content type is selected from the group including: text, graphics, audio, or video.

9. The method of claim 5, further comprising monitoring the content cell to measure the content cell load.

10. The method of claim 1, further comprising:
calculating a first cost for the forming a content cell; and
calculating a second cost for the communicating data of the content type.

11. A method of communicating in a network of interconnected communication nodes, comprising:
forming a plurality of content cells, wherein each content cell is associated with one of a plurality of content types, and wherein each content cell includes a subset of the communication nodes in the network;
communicating data of a first content type over a corresponding first content cell; and
communicating data of a second content type over a corresponding second content cell.

12. The method of claim 11, further comprising forming at least one subcell within a content cell for communicating data of a content type between a content provider and a network user.

13. The method of claim 12, further comprising switching from one content cell to another content cell based on a content type request from the network user

14. The method of claim 13, wherein the at least one subcell is formed in response to the request from the network user.

15. A method of controlling traffic in a network of interconnected communication nodes, comprising:
monitoring data traffic over the communication nodes;
parsing the data traffic into content types, there being a plurality of content types;
forming a plurality of content cells for communication of a corresponding content type, wherein each content cell includes a subset of the communication nodes; and
dynamically switching communication nodes in or out of a content cell based on the data traffic.

16. The method of claim 15, further comprising measuring a data traffic load of individual communication nodes.

17. The method of claim 15, wherein the plurality of content types include text, graphics, audio, and video.

18. The method of claim 15, further comprising calculating a cost for forming a content cell.

19. The method of claim 15, further comprising calculating a cost for switching communication of data of a content type into a corresponding content cell.

20. The method of claim 15, further comprising calculating a cost for communicating the data of the content type

21. The method of claim 16, wherein dynamically switching communication nodes in or out of a content cell is based on the data traffic load.

22. The method of claim 15, further comprising calculating a cost for communicating each unit of data of a particular content type over a particular content cell.

23. A communication system for transmission of various types of content in a network, comprising:
a plurality of network users;
a plurality of content providers;
a plurality of communication nodes, a subset of which are interconnected between at least one network user and at least one content provider;
a content manager, configured to form a content cell of communication nodes based on a content type of data being communicated between the at least one network user and at least one content provider.

24. The system of claim 23, wherein the content manager includes a plurality of content manager nodes.

25. The system of claim 24, wherein each content manager nodes is configured to monitor network traffic for at least one network user.

26. The system of claim 24, wherein each content manager is configured to form a subcell within a content cell, wherein the subcell forms a route of communicating nodes from a content provider to a network user.

27. The system of claim 25, wherein each content manager node is further configured to switch a communication node into a content cell based on the network traffic.

28. The system of claim 25, wherein each content manager node is further configured to switch a network user to a content cell based on data requests from the network user.

29. The system of claim 23, wherein the content manager is configured to calculate a cost of communicating data of a content type in a content cell.

30. The system of claim 29, wherein the cost includes a cost associated with the data, a cost associated with the forming a content cell, and the cost associated with the communicating the data.

31. The system of claim 23, further comprising a memory network device connected with each content provider, wherein the memory network device is configured to recognize the content type of data, parse the data based on the content type, and store the data in the content provider.

32. The system of claim 31, wherein the memory network device is configured to append a flag to the data, wherein the flag identifies the content type.
